(19) United States
(12) Patent Application Publication
(10) Pub. No.: US 2005/0033645 A1
(43) Pub. Date: Feb. 10, 2005

(54) Virtual cashier

(76) Inventor: Michele R. Duphily, Portland, OR (US)

Correspondence Address: LAW OFFICE OF DAVID MCEWING, P.O. BOX 231324, HOUSTON, TX, 77023, US

(21) Appl. No.: 10/016,101

(22) Filed: Oct. 31, 2001

Related U.S. Application Data
(60) Provisional application No. 60/244,495, filed on Oct. 31, 2000.

(51) Int. Cl. G06F 17/60

(52) U.S. Cl. 705/16

(57) ABSTRACT

This invention pertains to a method and apparatus that prepaid cards or similar mechanisms to identify money accounts from which payment can be made to merchants and others via electronic transfer, particularly thorough communication transmitted over the Internet. The invention can allow electronic transfer of money without disclosure of individual identity or financial information. The apparatus can accept cash or other forms of payment that can be then transferred via an Internet site, permitting the merchant to receive payment directly from the entity maintaining the Internet site. The operator of the Internet site (Internet portal) will undertake collection and accounting of payments received from individual users or purchasers. The invention also comprises an apparatus that can be utilized to provide Internet access to the public similar to a public telephone and ability to conduct financial transactions over the Internet similar to an ATM.

### CROSS REFERENCE TO RELATED APPLICATION

The applicant claims the benefit of U.S. Provisional application Ser. No. 60/224,495 entitled “Virtual Cashier” and filed Oct. 31, 2000.

### BACKGROUND TO THE INVENTION

1. Field of Invention

The invention subject of this application pertains to a business method for utilizing various payment mechanisms for business or consumer transactions including, but not limited to, purchases of goods and services via electronic medium. Electronic medium may include, but is not limited to, the Internet, telephone, radio, cable (such as cable TV), digital and satellite communication systems (such as TV's, pagers and phones) as well as all types of hand held computing devices. Although this invention is not limited to the Internet, all methods of electronic transmissions will be referred to herein as the Internet. The method may be utilized in conjunction with computer software. The invention also pertains to an apparatus that can be used by purchasers desiring to utilize the Internet to make purchases. The method allows purchases through the Internet with or without credit cards yet provides merchants with the same assurances of payment at the time the transaction is entered into. The apparatus subject of this invention is capable of accepting cash or electronic payment.

2. Prior Art

Electronic or electronically readable payment cards have long been utilized in commerce. Information has been encoded on magnetic strips placed on credit cards to allow rapid and automated verification of the credit card and account status as part of each transaction. Electronic scanners have been utilized that access consumer personal financial account information and require no direct merchant activity. This is experienced almost daily when purchasing gas by credit card or debit card.

Individual merchants also issue prepaid cards allowing the purchase of goods or services at a later time or different location. Prepaid merchant cards may also be readily transferable and given as gifts. Prepaid telephone cards are also known. These actuated telephone cards can be purchased through vending machines. They permit the user to a certain amount of time for toll telephone charges. Prepaid Internet access accounts have also been utilized. These prepaid accounts, established with an Internet Service Provider (ISP), allow the user a specified time of Internet access.

However, prepaid cards do not permit the user to purchase any goods or services through the Internet with multiple vendors and multiple locations. They also do not allow refund or transfer of unspent balances. There is also not a systematic method of locating merchants or other providers of goods and services that will accept such payment mediums. There is also not a mechanism for pubic accesses to the Internet for purchase of goods and services, gaming, or other items in a manner similar to public access to the telephone network or, more recently, banking services via ATMs.

### SUMMARY OF THE INVENTION

The invention subject of this application pertains to a business method for utilizing various payment mechanisms for business or consumer transactions including, but not limited to, purchase of goods and services via electronic medium. Electronic medium may include, but is not limited to the Internet, telephone, radio, cable (such as cable TV) or digital and satellite communication systems. Although this invention is not limited to the Internet, all methods of electronic transmission will be referred to herein as the Internet. More specifically, it pertains to a systematic and comprehensive method of dispensing cards or other tangible medium that represents a prepaid monetary accounts that may be accessed only through the use of the card (hereinafter termed “prepaid card”, “Virtual Cashier card” or “V-C card”). The account can not be accessed except by conveying the card or card identifier specific to that account. This prepaid card system can also allow a merchant or service provider to directly verify with the holding or possessing access to the money within the account represented by the V-C card that payment for any good or service will be made.

The method subject of this invention incorporates a plurality of steps. All steps are not required and some of the steps or elements of the business method may be substituted for other steps.

It is therefore a goal of the present invention to allow persons (hereinafter deemed to include businesses) without credit cards to purchase goods and services through the Internet.

It is yet another goal of the present invention to allow persons to make purchases through the Internet that are unwilling to disclose credit card or other personal financial account information on the Internet.

It is another goal of the present invention to provide a portal through which prospective purchasers of goods and services utilizing VC cards, conventional credit cards or other forms of prepaid electronic payment cards may be linked to providers of goods and services that accept such payment medium.

It is another goal of the present invention to allow persons to electronically make installment payments in the purchase of goods and services without credit cards or access to other forms of credit.

It is another goal of the present invention to allow persons to make installment payments in the purchase of goods and services without disclosing credit card or other personal financial information.

It is yet another goal of the invention to provide a business method that will give merchants prompt and reliable assurance that payment will be made for transactions with unknown or unidentified purchasers and without use of credit cards, bank debit cards or the prepaid individual merchant cards.

It is another goal to provide a portal or mechanism through which a purchaser may select merchandise or services through the Internet and the conveyance of the purchase price being made to the merchant by the entity maintaining the portal (“portal operator”) in exchange for deduction of a comparable or related monetary value from an existing monetary account or fund established by the purchaser and possessed by or accessible to the portal operator.

It is another goal of the invention to provide merchants with payment for completed transactions within an amount of time comparable to the amount of time for merchants to receive payment on credit card purchases.

It is yet another goal of the invention to provide an apparatus that can accept the payment in the form of cash tendered by a purchaser in a transaction conducted via the Internet and that the monetary amount representative of the value of the cash can be electronically conveyed to a merchant or credited to a payment made by the portal operator directly to the merchant.

It is still another goal of the invention to provide an apparatus for that can receive prepaid account cards such as the V-C card or comparable card issued by other entities.

It is yet another goal of invention to provide an apparatus that can verify the validity of prepaid cards, credit cards or bank debit cards for the merchants that are not otherwise equipped or registered to accept credit cards or similar devices.

It is yet another goal of the invention to provide an apparatus that will allow purchasers to shop or make other payment through the Internet utilizing public internet terminals without disclosing, by 'swiping” or otherwise, information contained on credit cards, debit cards or other financial or personal identifying information

It is yet another goal of the invention to provide an internet forum or portal for merchants to list products, services, special offerings, information or links to their own web sites. This portal may be readily accessed to by consumers at the machine subject of this invention that will accept a wide variety of payment medium, including but not limited to credit card, bank debit card, prepaid V-C Cards or cash.

It is yet another goal of the invention to provide an apparatus for accessing to the Internet that allows the identity of the user to be recorded or verified by means other than transmission of financial or related personal information, e.g., social security number, credit card numbers or bank account numbers.

### SUMMARY OF DRAWINGS

FIG. 1A illustrates an embodiment of the business method subject of this invention.

FIG. 1B illustrates the flow and interface of information in one embodiment of the invention.

FIGS. 2A and 2B illustrate the information process that may be conducted in an embodiment of the subject invention.

FIG. 3 illustrates an embodiment of the invention showing the options available to a consumer utilizing the subject invention.

FIG. 4 is another embodiment of the invention.

FIG. 5 illustrates options available to merchants utilizing the subject invention.

FIG. 6 illustrates another embodiment of the invention.

FIGS. 7, 8, 9 and 10 illustrate other embodiments of the invention utilized in conjunction with alternative payment mechanisms.

FIG. 11 illustrates the processing of information for account reporting.

FIGS. 12 and 13 illustrate the processing of information for functions selected by a consumer utilizing the invention.

FIGS. 14, 15 and 17 illustrate the processing of information utilized for transferring money from one consumer to another through an embodiment of the invention.

The above general descriptions and the following detailed descriptions are merely illustrative of the generic invention and additional modes, advantages, and particulars of this invention will be readily suggested to those skilled in the art without departing from the spirit and scope of the invention.

### DETAILED DESCRIPTION OF THE INVENTION

The present invention pertains to a business method for utilizing various forms of payment mechanisms for business or consumer transactions, including but not limited to the purchase of goods and service through various electronic media, hereinafter termed the Internet.

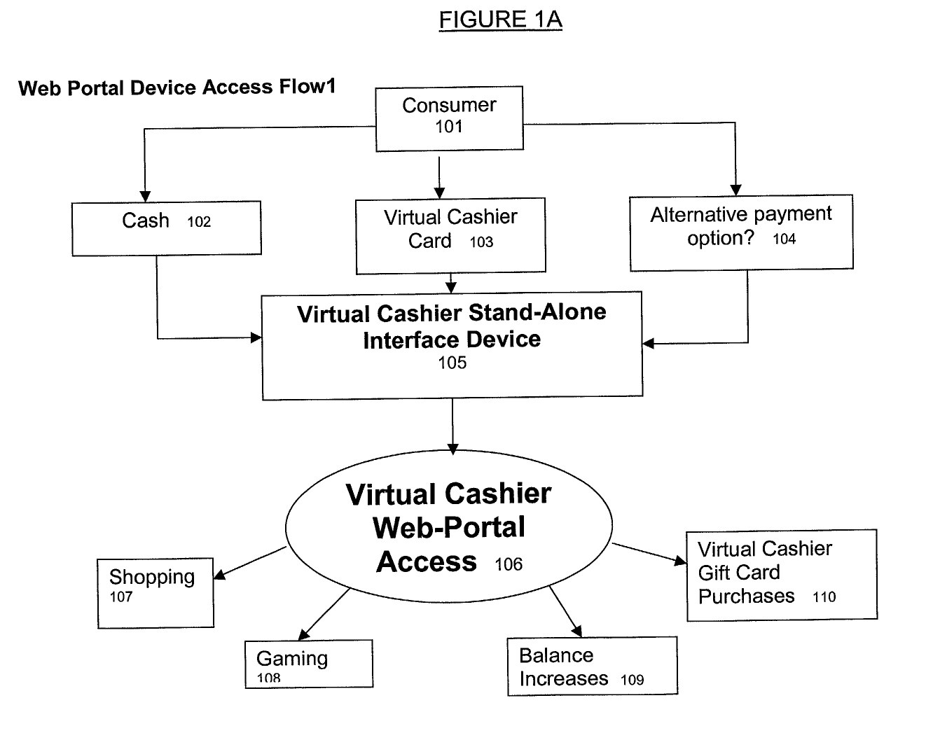

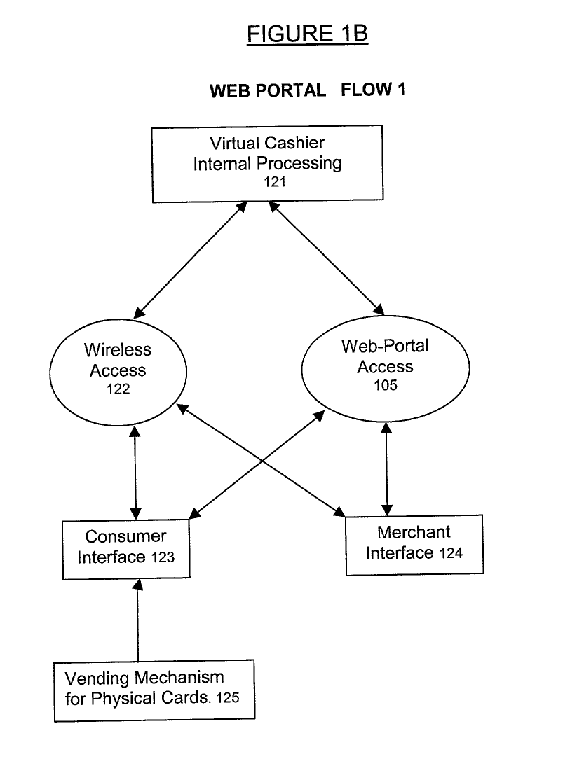

The prospective purchaser can access the Internet by conventional means or through a stand-alone device also claimed as part of the present invention. Through the Internet, the prospective purchaser (hereinafter “purchaser”) accesses the Virtual Cashier Web Portal (“Internet portal”) subject of the invention. The Internet portal can include an Internet website containing categorized links to participating merchant websites accepting payment by V-C Cards or similar prepaid cards as forms of electronic payment so that a purchaser can readily locating merchant accepting this type of payment. FIG. 1A illustrates payment options that may be available to the purchaser via this Internet portal. It will be readily appreciated that the use of the “Virtual Cashier Stand-Alone Interface Device 105 (or “Internet terminal”) will allow the purchaser 101 to utilize multiple payment mechanisms, including direct deposit of cash currency 102, credit cards 104 or the Virtual Cashier Card (“prepaid card”) 103. Alternatively, the purchaser may utilize conventional electronic payment mechanisms, as well as the prepaid cards, though the “Virtual Cashier Web-Portal Access” 106 (Internet portal) from a personal computer connected to the Internet. It will also be appreciated after reading the description of this invention that the various options 107, 108, 109 and 110 are only limited examples of activities that can be undertaken utilizing a prepaid card with the Internet portal.

FIG. 1B illustrates the interrelationship between various components that can be incorporated into the subject invention. The Virtual Cashier Internal Processing 121 is a function performed by the Internet portal operator. This includes the accounting of various prepaid accounts, matching the accounts with PIN numbers or prepaid card numbers (“prepaid card identifiers”) as part of V-C Card validation, processing payments to merchants from separate prepaid accounts, computing and withholding transaction fees, etc. This relationship can also include maintaining actual Internet terminals 105 that may be accessible to the public or to individuals, an Internet Service Provider (ISP) 122, as well as the liaison and marketing to both merchants 124 and purchasers 125. Note also that the invention incorporates any form of distribution and vending of prepaid cards 126.

As discussed, one feature of the invention is Virtual Cashier Interface Devices (Internet terminals) 105 could be placed in locations such as libraries, transportation terminals, coffee shop, bars, etc., thereby bringing instant access to Internet services to people away from their personal computers. In this manner, the Virtual Cashier Interface Device may resemble a public telephone or ATM. However, as will be appreciated after thorough understanding of this description, the subject invention includes security features not contained in other devices.

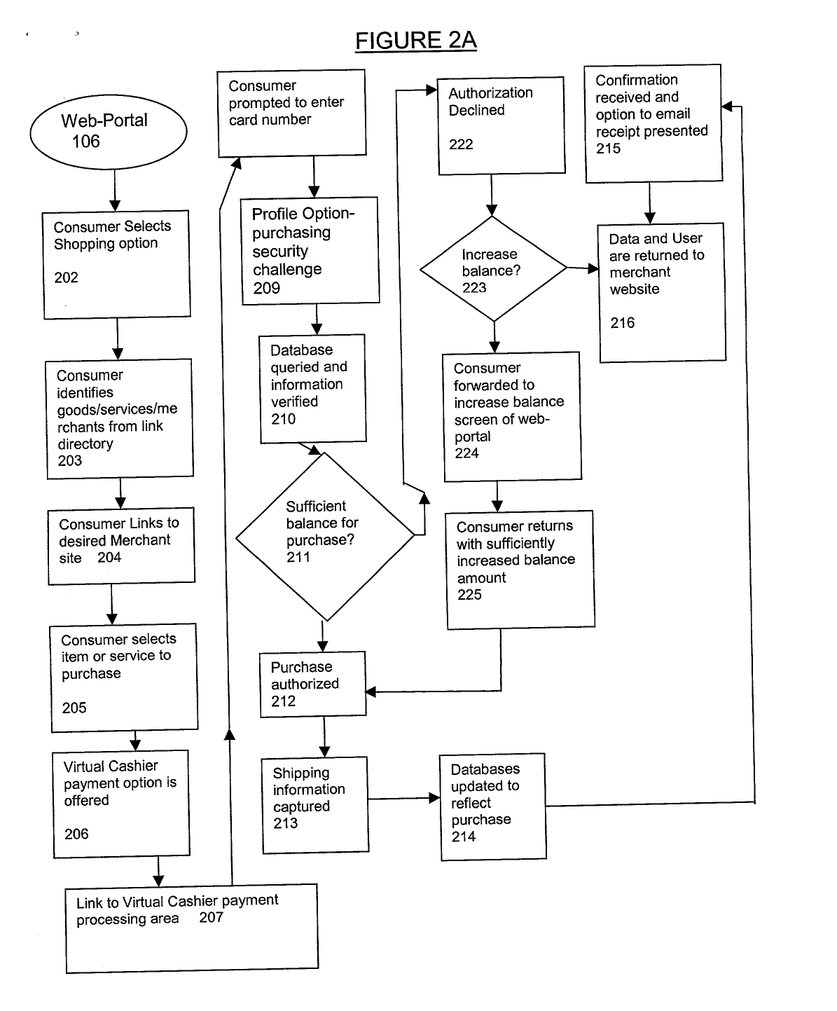

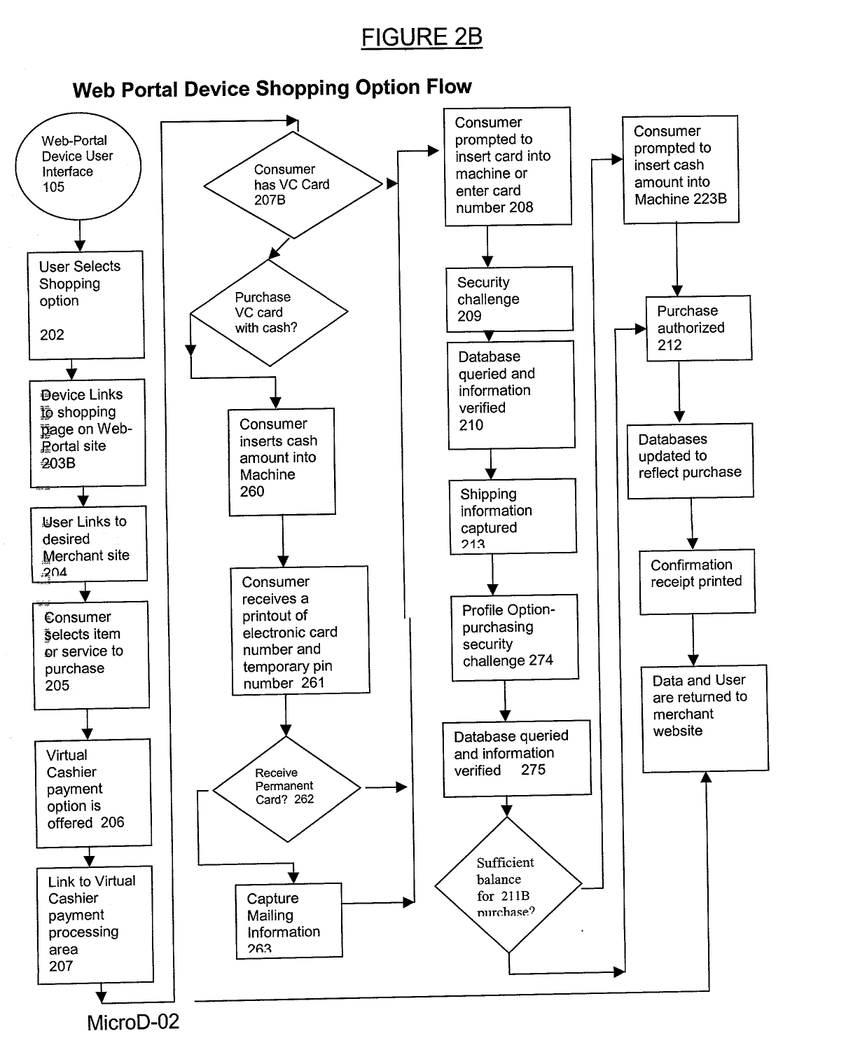

FIG. 2A and FIG. 2B illustrate embodiments of the process steps included in the instant invention. Note that the purchaser begins by accessing the Internet, either via a personal computer as in FIG. 2A or a stand alone Virtual Cashier Interface Device 105 in FIG. 2B and used to access the Virtual Cashier Web Portal Assess 106 (“Internet portal” or “Web Portal”). Alternative steps or embodiments of the process may include the following:

1. Purchaser accesses the Internet via computer or Virtual Cashier Interface Device;

2. Purchaser logs on to the Internet page or website of the Virtual Cashier Web Page (Web Portal),

3. Consumer selects activities from menu;
(Option: If Consumer selects icon or menu button for goods and services, the Consumer can elect to proceed to a to a specific merchant site or selected Virtual Cashier page containing identified group of goods or services.)

4. Quantity and availability of identified goods are confirmed (at either the Virtual Cashier Web Portal or via specific merchant website) 204.

5. Price is confirmed.

6. Consumer selects method of payment.

7. Virtual Cashier Web Portal, either directly with Consumer or through a separate link with the merchant's web site, verifies receipt of payment and credits merchant account

8. User gives instructions for delivery of goods or services 213.

9. User receives confirmation of transaction (confirmation number or printed receipt) 215.

If the Consumer selects an alternate option, e.g., gaming, movie or similar activity available on a time charge or toll basis, payment can be made via the several options, including VC cards (“pre-paid cards”), credit cards, or cash. Note that these payment methods and the Virtual Cashier Web Portal may also be utilized via other mechanisms that provide Internet access, including portable mechanisms such as hand held computing devices, digital and cellular phones, pagers or similar devices. It is also contemplated that terminals can be captive of only selected sites, such as the Web Portal, perhaps combined with general information sites such as news and weather.

FIG. 2B also illustrates optional security checks that may be particularly useful when conventional credit or debit cards are utilized 274 and 275. It will further be appreciated that the sequence of steps set forth in FIGS. 2A and 2B are for illustration only and are not limitations of the invention.

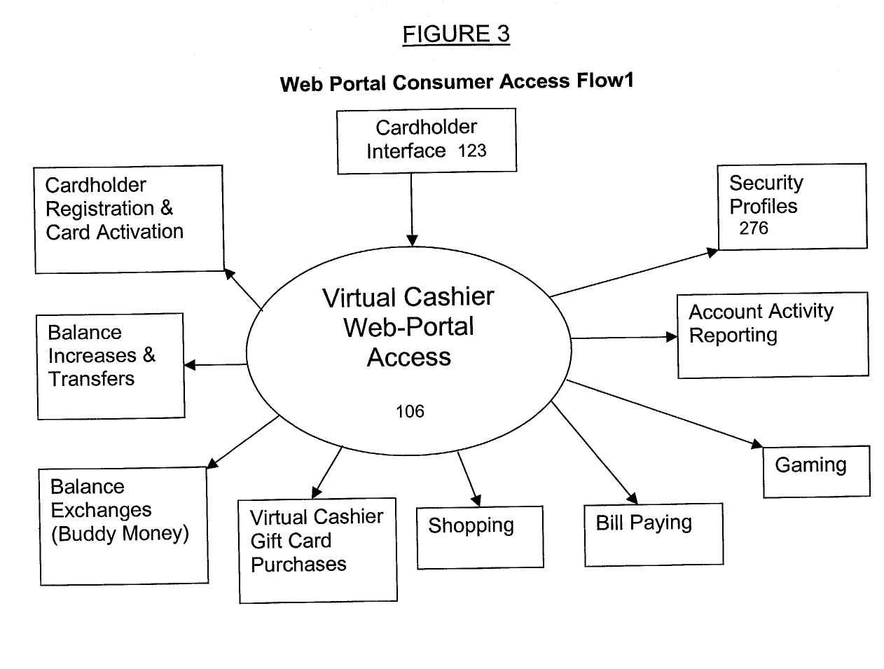

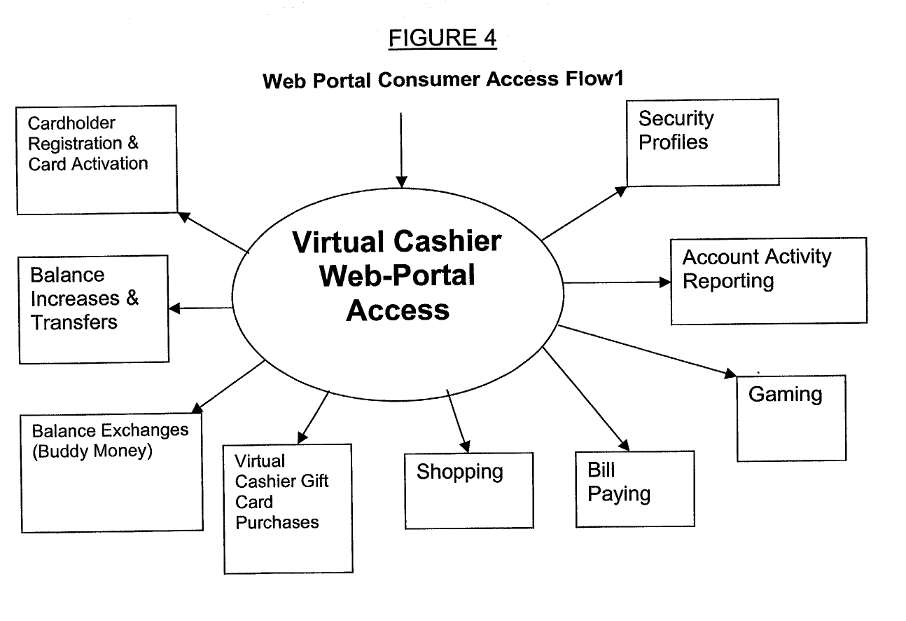

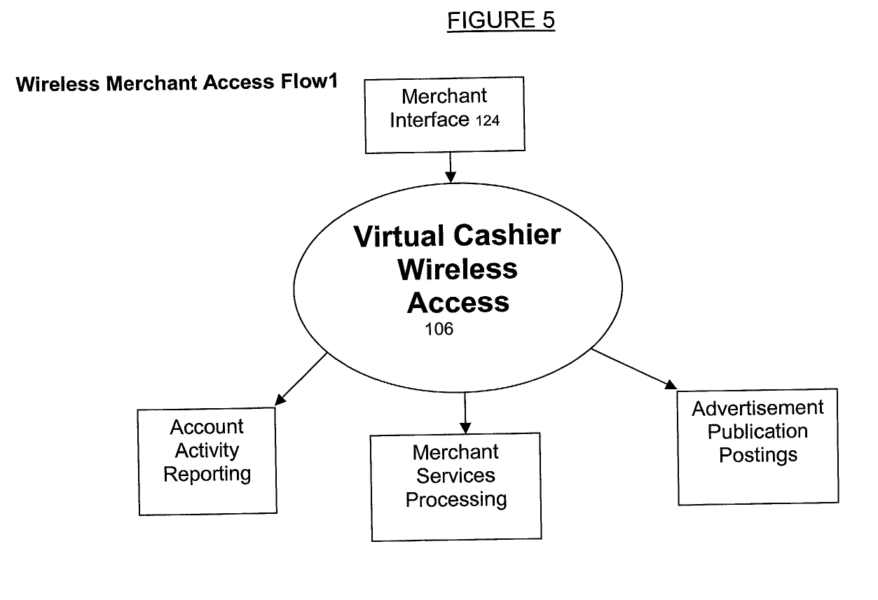

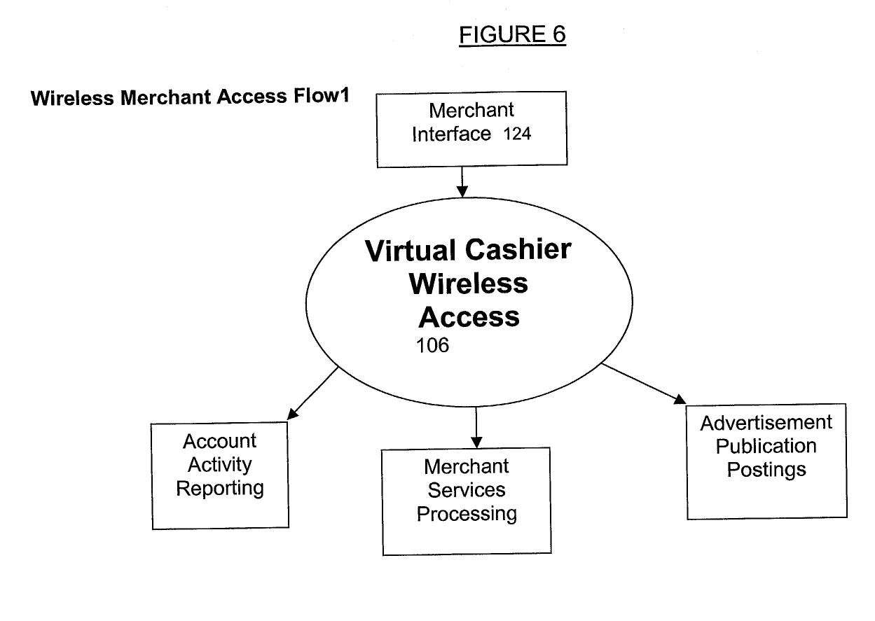

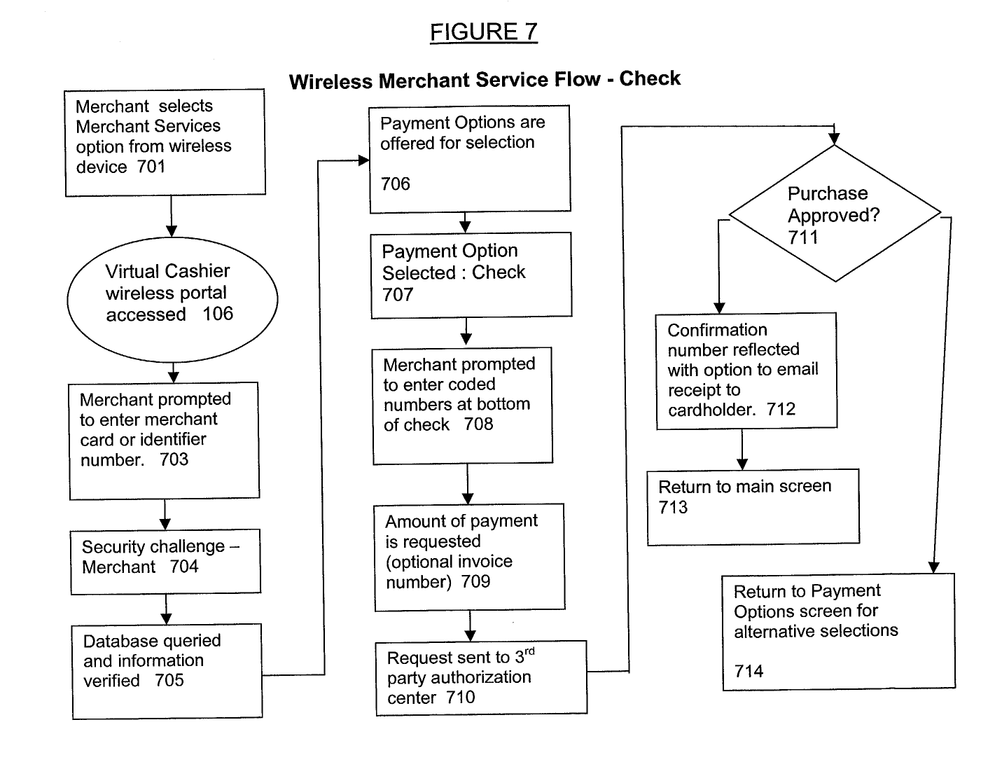

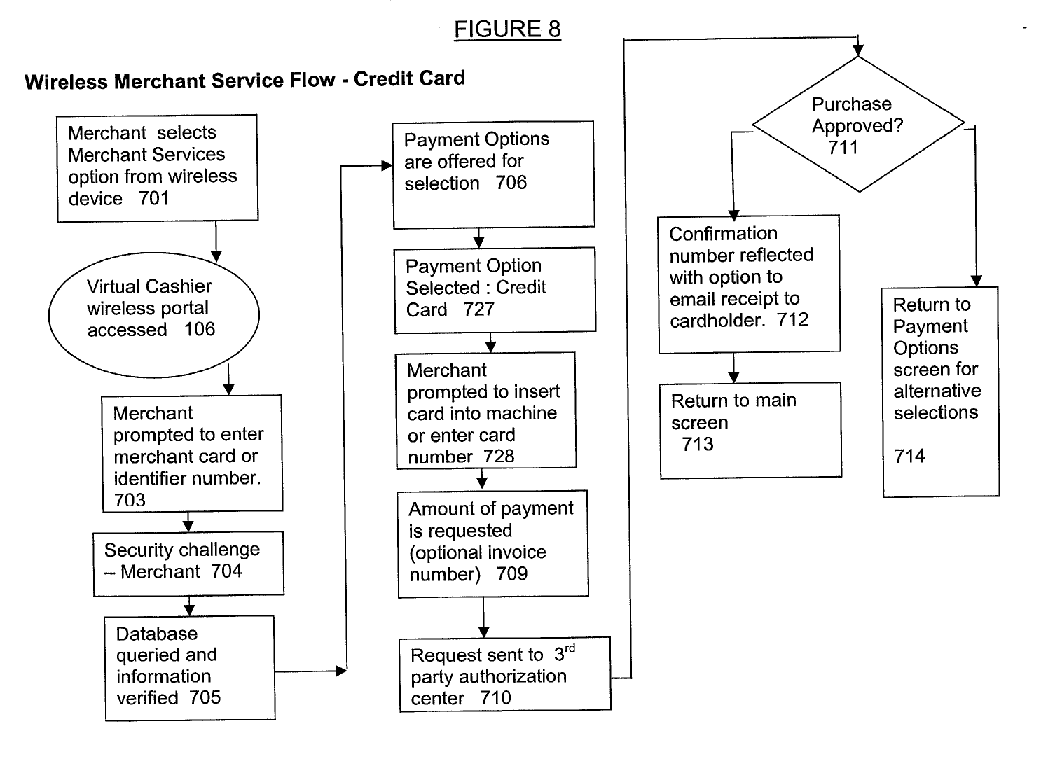

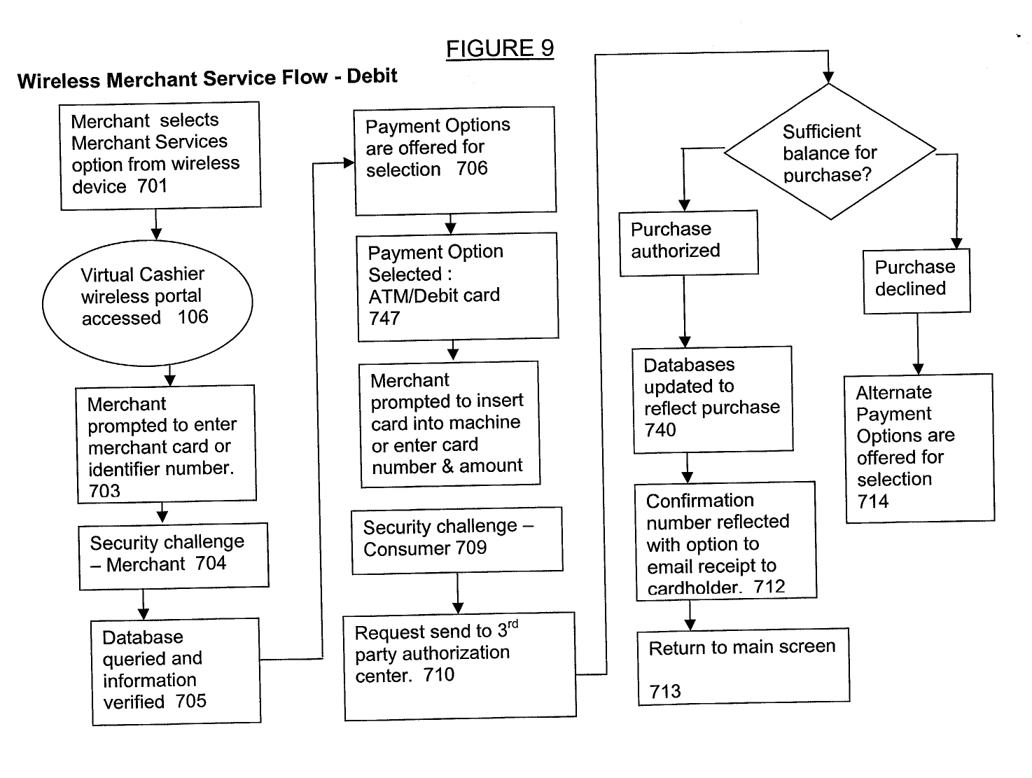

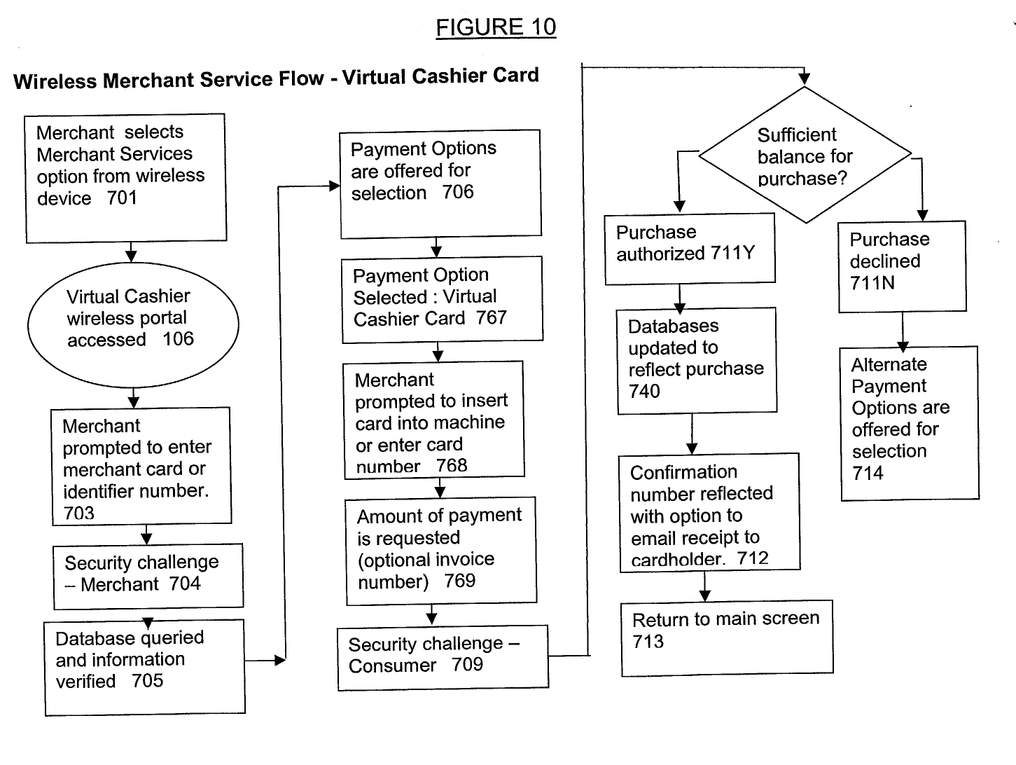

FIGS. 3 and 4 illustrate some of the options available to the Consumer via the Virtual Cashier Portal Access site 106 subject of this invention. FIG. 5 illustrates the information and activity options available to Merchants participating in the Virtual Cashier Web Portal. Note FIG. 6 illustrates a more limited range of options that may be available to the Merchant via the Wireless Merchant Access Services. The method is further illustrated in FIGS. 7 through 10.

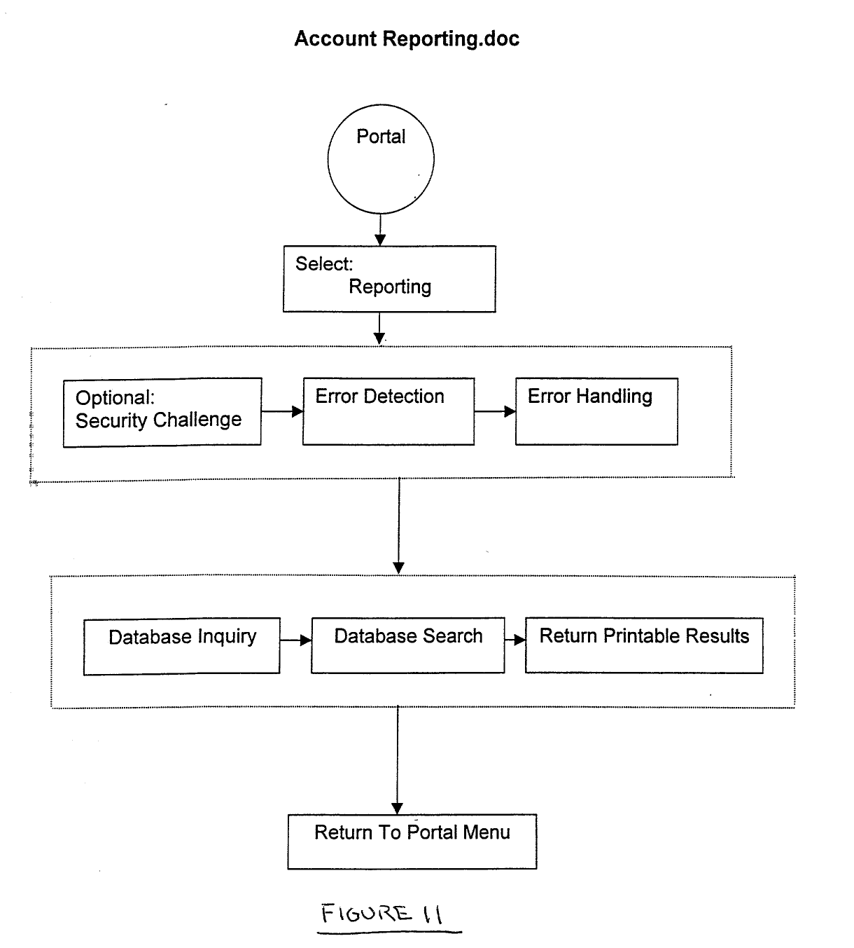

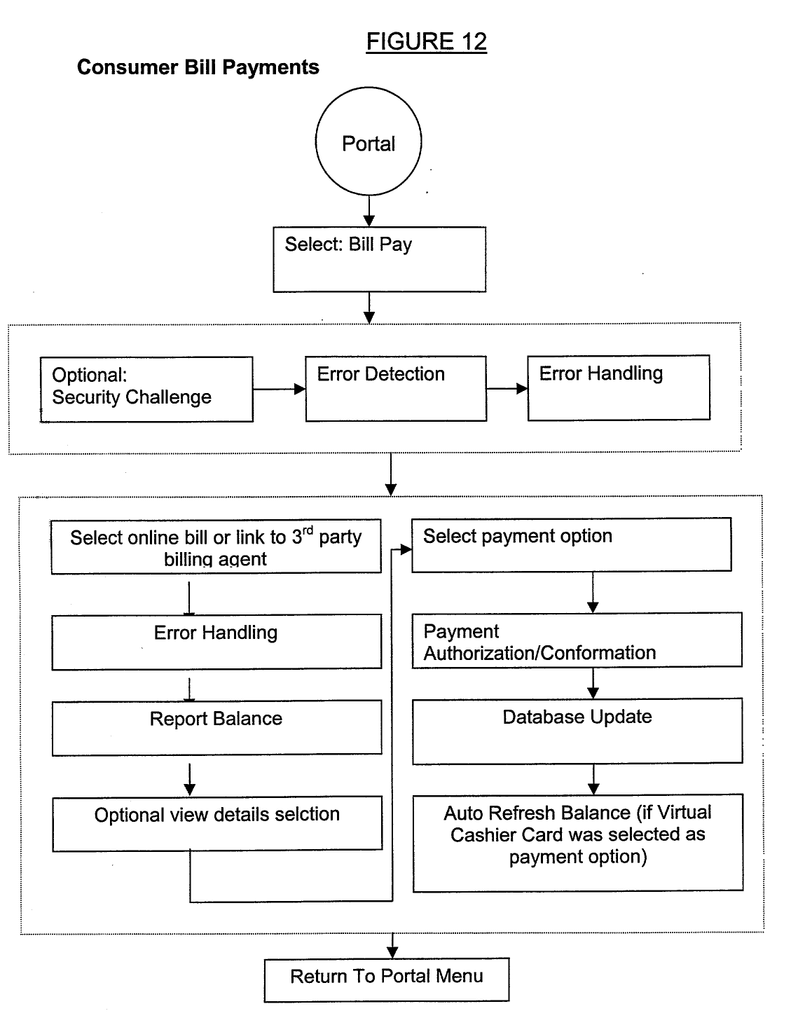

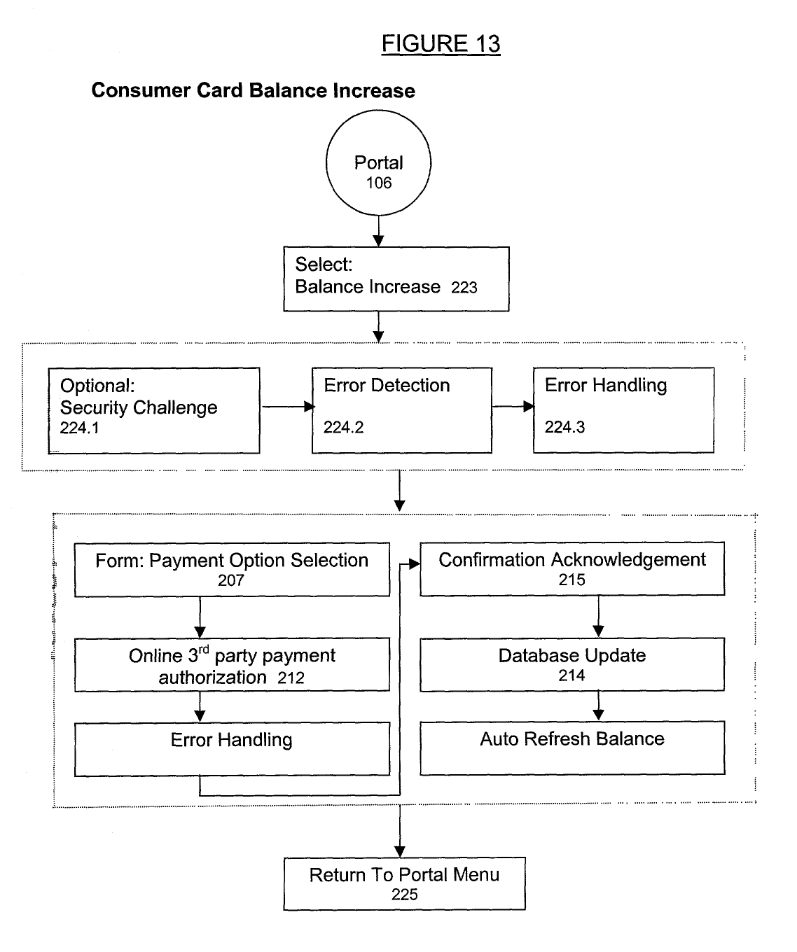

FIGS. 11 through 13 provide expanded explanation of process steps that may be utilized in a Consumer or Merchant transaction. Note for example that FIG. 13, Consumer Card Balance Increases 223, is a step contained within the embodiment of the invention illustrated in 2A 223 and 2B 223B.

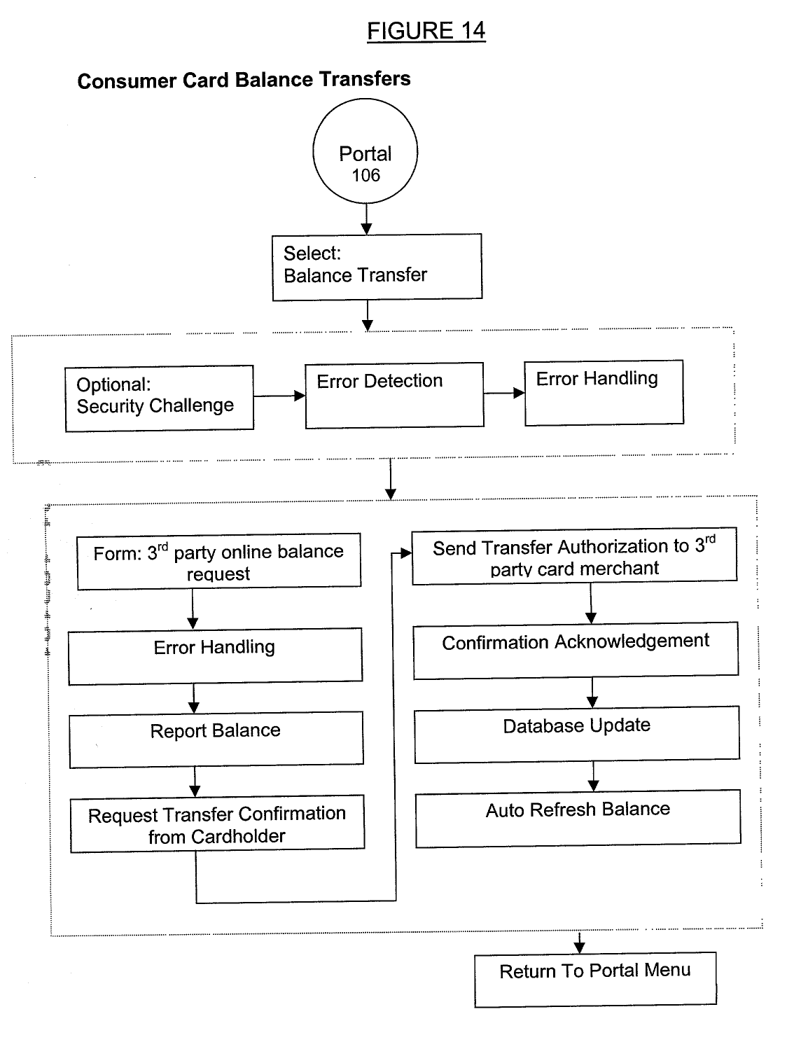

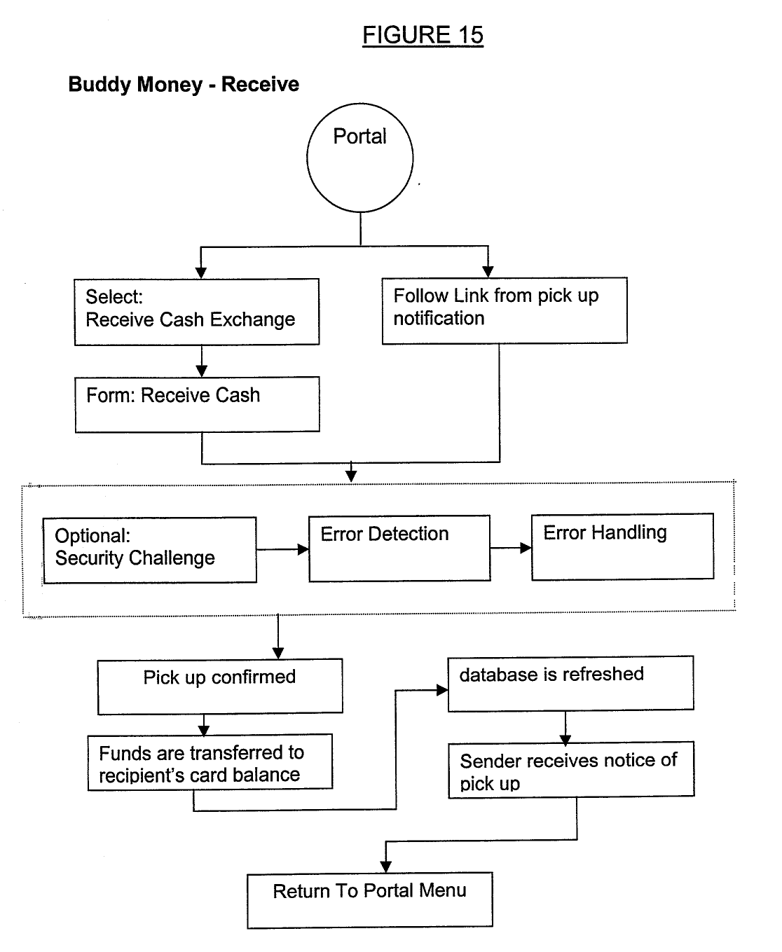

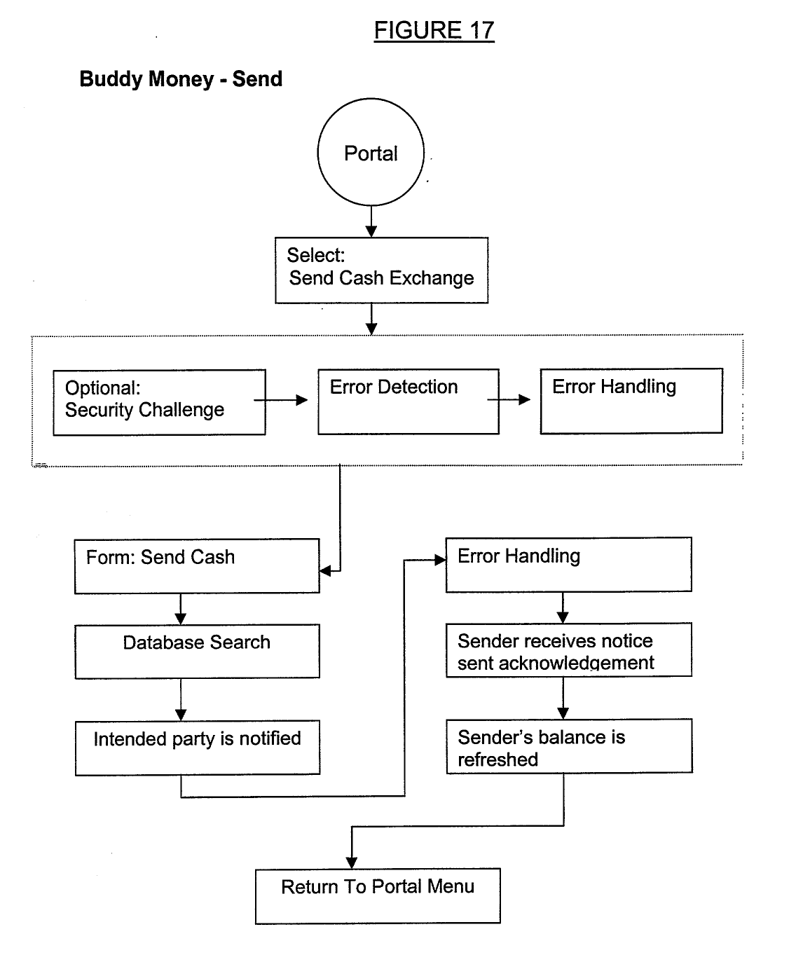

FIGS. 14, 15 and 17 illustrate an embodiment of the invention that may be utilized to electronically transfer money (“Buddy Money”), either by deposits of cash or prepaid cards (“V-C cards”). Note that this allows the transfer of payment or money without disclosure of banking or similar financial information.

The invention also includes alternate embodiments of the Virtual Cashier Interface Device that allows a purchaser to have access to the Internet or a selected subset of sites or specialized websites. The apparatus may be located in public places such as airline terminals, shopping malls, hotel rooms and lobbies, office buildings, eating and drinking establishments, airplanes, commuter trains, or similar locations.

The apparatus may consist of a video screen, a CPU, computer modem, cable connection, satellite or digital connection, DSL connection, T-1 connection or other means that allow messages to be transmitted to and from the user via the Internet. In a preferred embodiment, the apparatus also contains a keyboard, a mouse or mouse button, any other type of device that allows the user to (move icons or cursors to be moved about on) interact with the computer screen. In other embodiments, the apparatus utilizes a touch screen that is activated by touch or light. The apparatus may also have the capability to provide information audibly and respond to audible commands.

The apparatus may also have mechanism to accept and recognize paper currency or coins, compute the value of the coins and currency inserted into the apparatus and transmit this information via the Internet. It will be readily appreciated after acquiring a thorough understanding of the invention that this can include transfers of money to the Virtual Cashier Wireless Portal Access (Internet portal website). FIG. 1A illustrates one aspect of this embodiment. This embodiment also facilitates increasing the prepaid account in FIGS. 2A, 223 and 2B 223B.

The apparatus may also have a mechanism to allow information contained in bar codes scanned into the machine and the information read and transmitted over the Internet,

1. A method of purchasing goods and services through the Internet comprising:
a. accessing an Internet website containing a listing merchandise and services that can be purchased by communication through the Internet,
b. inputting the selection of the merchandise and services for purchase and a prepaid card identifier,
c. transmitting the selection and prepaid card identifier,
d. obtaining verification that a monetary account represented by the prepaid card contains a monetary balance at least equal to the value of the merchandise and services selected,
e. transferring the monetary value of the selected merchandise and services from the account to the vendor, and
f. obtaining the purchased merchandise and service.

2. The method of claim one further comprising an internet website communicating the purchaser's selection to the vendor, issuing payment to the vendor and obtaining payment from the monetary account the prepaid card identifier communicated to the internet website by the purchaser.

3. The method of claim 2 further comprising the ability of the purchaser to pay the purchase price in installments.

4. The method of claim 1 or 2 further comprising the Internet website issuing payment to creditors of the purchaser and obtaining payment from the monetary account represented by the prepaid card identifier communicated to the Internet website by the purchaser.

5. The method of claim 1 or 2 further comprising the Internet website issuing payment to creditors of the purchaser and obtaining payment from a combination of deduction from the monetary account represented by the prepaid card identifier communicated to the Internet website by the purchaser, payment of cash, check or credit card. or similar device.

6. The method of claims one or two wherein an entity maintaining the Internet website also holds the monetary account represented by the prepaid card identifier.

7. The method of claims one or two wherein the entity maintaining the Internet website also is the entity issuing prepaid cards.

8. An apparatus comprising;
a. a video monitor,
b. a CPU,
c. an Internet connection for receipt and transmission of information, and
d. a device that can accept the deposit of currency, compute the amount of the currency deposited, and communicate the amount deposited via the Internet.

9. The apparatus of claim 8 further comprising a device for reading the electronically encoded information.

10. The apparatus of claim 8 further comprising means for reading bar coded information.

11. The apparatus of claim 8 further comprising a keyboard,

12. The apparatus of claim 8 further comprising a computer mouse.

13. The apparatus of claim 8 further comprising a mechanism for moving cursor on the video screen and activating icons, visual links or instructions placed on the video screen.

14. The apparatus of claim 8 further comprising a mechanism for recording the identity of the individual using the apparatus.

15. The apparatus of claim 11 wherein the mechanism for recording the identity of the user comprises an apparatus that records at least one finger print.

16. The apparatus of claim 12 wherein the finger print recording mechanism is incorporated into the screen of the video monitor.

17. The apparatus of claim 13 further comprising the capability to video record the user of the apparatus wherein the user and the finger print recording mechanism are video recorded.
